(19) United States
(12) Patent Application Publication
(10) Pub. No.: US 2022/0294918 A1
(43) Pub. Date: Sep. 15, 2022

(54) IMAGE FORMING APPARATUS THAT DISPLAYS USAGE STATUS OF TOUCH PANEL

(71) Applicant: KYOCERA Document Solutions Inc., Osaka (JP)

(72) Inventor: Masanori KYOGOKU, Osaka (JP)

(73) Assignee: KYOCERA Document Solutions Inc., Osaka (JP)

(21) Appl. No.: 17/689,697

(22) Filed: Mar. 8, 2022

(30) Foreign Application Priority Data
Mar. 11, 2021 (JP) 2021-039580

(51) Int. Cl. H04N 1/00

(52) U.S. Cl. CPC H04N 1/00411; H04N 1/00392; H04N 1/00323; H04N 1/0049; H04N 2201/0094

(57) ABSTRACT

In an image forming apparatus, a controller makes a determination of whether or not a person present around the image forming apparatus has been detected by a motion sensor, makes a determination of whether or not a touch gesture has been made on a touch panel, counts, based on results of the determinations, a number of users of the image forming apparatus, a number of touch gestures on the touch panel or an elapsed time since a latest touch gesture on the touch panel, and allows a display device to display the number of users, the number of touch gestures or the elapsed time.

### INCORPORATION BY REFERENCE

This application claims priority to Japanese Patent Application No. 2021-039580 filed on Mar. 11, 2021, the entire contents of which are incorporated by reference herein.

### BACKGROUND

The present disclosure relates to image forming apparatuses equipped with a touch panel on which a user makes a touch gesture and particularly relates to a technique for allowing a display device to display the frequency of use of the touch panel and like information.

As is well known, in an image forming apparatus, an image reading device reads an image of an original document and an image forming device forms the image of the original document on a recording paper sheet. Meanwhile, there is known an image forming apparatus which includes a display device capable of displaying a GUI (graphic user interface) or the like and a touch panel disposed on top of the screen of the display device, detects through the touch panel a gesture made on the GUI or the like displayed on the screen of the display device, and operates in response to the gesture.

If a large number of unspecified people use an image forming apparatus, some users may want to avoid inadvertent touch on the touch panel.

There is also known a display input device in which a scanner is disposed in a space between a clear touch panel and a display screen, a reference plate is disposed above the touch panel, the scanner reads the surface of the reference plate through the touch panel while the scanner and the reference plate coupled with each other move together, a position of dirt on the touch panel is determined based on an image obtained by reading the surface of the reference plate, and the position of dirt is cleaned with a brush or the like.

There is also known a cleaning work support device that takes an image of the surface of a touch panel with a camera, detects a position of dirt on the touch panel, how the dirt is, and so on based on the image of the surface of the touch panel, and displays the detected position of dirt, the look of the dirt, and others on the screen of a display device on top of which the touch panel is laid.

### SUMMARY

A technique improved over the aforementioned techniques is proposed as one aspect of the present disclosure.

An image forming apparatus according to an aspect of the present disclosure includes a display device, a touch panel, a motion sensor, and a control device. The touch panel is provided on a screen of the display device. The motion sensor detects a person present around the image forming apparatus. The control device includes a processor and functions, through the processor executing a control program, as a controller. The controller makes a determination of whether or not a person present around the image forming apparatus has been detected by the motion sensor, makes a determination of whether or not a touch gesture has been made on the touch panel, counts, based on results of the determinations, a number of users of the image forming apparatus, a number of touch gestures on the touch panel or an elapsed time since a latest touch gesture on the touch panel, and allows the display device to display the number of users, the number of touch gestures or the elapsed time.

### BRIEF DESCRIPTION OF THE DRAWINGS

FIG. 1 is a cross-sectional view showing an image forming apparatus according to one embodiment of the present disclosure.

FIG. 2 is a block diagram showing an essential configuration of the image forming apparatus according to the one embodiment.

FIG. 3A is a flowchart showing a control procedure for allowing a display device to display the number of users of the image forming apparatus, the number of touch gestures on a touch panel, and the elapsed time since the latest touch gesture on the touch panel.

FIG. 3B is a flowchart showing a portion of the control procedure continued from FIG. 3A.

FIG. 4 is a view showing a screen of the display device on which the number of users of the image forming apparatus, the number of touch gestures on the touch panel, the elapsed time since the latest touch gesture on the touch panel, and so on are displayed.

FIG. 5 is a plan view showing a modification of an operation device of the image forming apparatus.

FIG. 6 is a plan view showing another modification of the operation device of the image forming apparatus.

### DETAILED DESCRIPTION

Hereinafter, a description will be given of an image forming apparatus according to an embodiment serving as an aspect of the present disclosure, with reference to the drawings.

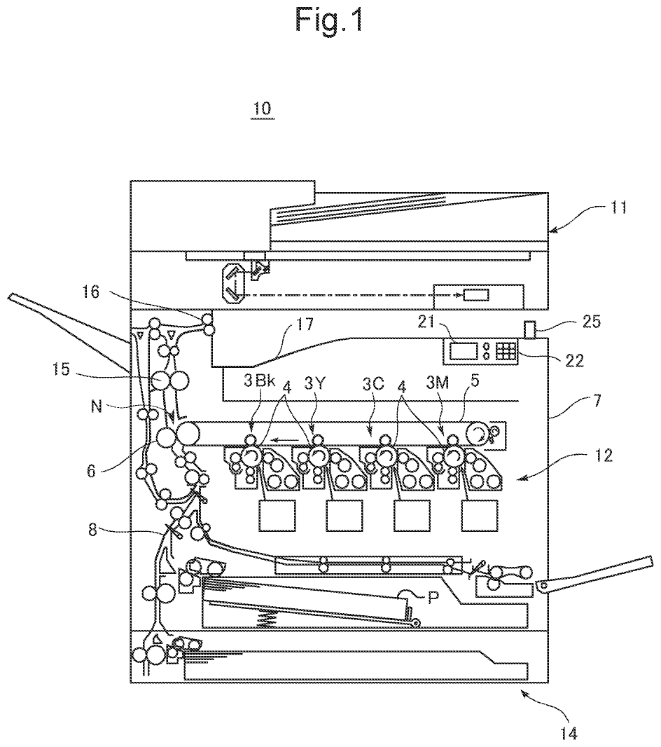

FIG. 1 is a cross-sectional view showing an image forming apparatus according to one embodiment of the present disclosure. As shown in FIG. 1, an image forming apparatus 10 according to this embodiment is a multifunction peripheral (MFP) having multiple functions, such as a copy function, a print function, and a facsimile function. The image forming apparatus 10 includes an image reading device 11 and an image forming device 12.

The image reading device 11 includes an image pickup device (such as a CCD sensor) capable of optically reading an image of an original document. An analog output of the image pickup device is converted to a digital signal to generate image data representing the image of the original document.

The image forming device 12 is a device that forms an image represented by the above image data on a recording paper sheet, and includes an image forming unit 3M for magenta, an image forming unit 3C for cyan, an image forming unit 3Y for yellow, and an image forming unit 3Bk for black. Each of these image forming units 3M, 3C, 3Y, and 3Bk uniformly charges the surface of a photosensitive drum 4, exposes the surface of the photosensitive drum 4 to light to form an electrostatic latent image on the surface of the photosensitive drum 4, develops the electrostatic latent image on the surface of the photosensitive drum 4 into a toner image, and primarily transfers the toner image on the surface of the photosensitive drum 4 to an intermediate transfer belt 5. Thus, a multicolor toner image is formed on the intermediate transfer belt 5. This multicolor toner image is secondarily transferred, at a nip region N between the intermediate transfer belt 5 and a secondary transfer roller 6, to a recording paper sheet P conveyed from a sheet feed device 14 via a conveyance path 8.

Thereafter, heat and pressure are applied to the recording paper sheet P by a fixing device 15, so that the toner image on the recording paper sheet P is fixed by heat and pressure. Then, the recording paper sheet P is discharged through an ejection roller 16 to a sheet output tray 17.

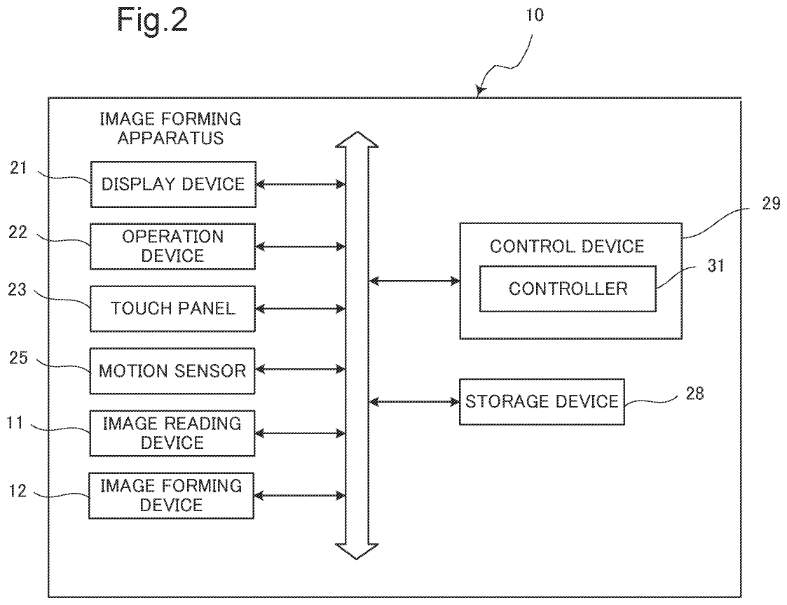

Next, FIG. 2 is a block diagram showing an essential internal configuration of the image forming apparatus 10 according to this embodiment. As shown in FIG. 2, the image forming apparatus 10 according to this embodiment includes the image reading device 11, the image forming device 12, a display device 21, an operation device 22, a touch panel 23, a motion sensor 25, a storage device 28, and a control device 29. These components are capable of data or signal transfer via a bus among them.

The display device 21 is formed of a liquid crystal display (LCD), an organic EL (organic light-emitting diode (OLED)) display or the like.

The operation device 22 includes physical keys, including numeric keys, an Enter key, and a Start key.

The touch panel 23 is provided over the screen of the display device 21. The touch panel 23 is a touch panel of a so-called resistive film system or a capacitance system, detects a touch on the touch panel 23 with a user's finger or the like, together with a point of the touch, and outputs a detection signal indicating the coordinate of the point of touch to a below-described controller 31 of the control device 29 and so on.

The motion sensor 25 is a known sensor that detects a person present in front of the image forming apparatus 10. For example, the motion sensor 25 is an infrared sensor that detects infrared rays emitted from a human body.

The storage device 28 is a large storage device, such as an SSD (solid state drive) or an HDD (hard disk drive) and stores various types of application programs and various types of data.

The control device 29 is made up of a processor, a RAM (random access memory), a ROM (read only memory), and so on. The processor is, for example, a CPU (central processing unit), an ASIC (application specific integrated circuit) or an MPU (micro processing unit). When a control program stored in the above ROM or the storage device 28 is executed by the above processor, the control device 29 functions as the controller 31.

The controller 31 performs the overall control of the image forming apparatus 10. The control device 29 is connected to the image reading device 11, the image reading device 12, the display device 21, the operation device 22, the touch panel 23, the storage device 28, and so on. The controller 31 performs the operation control of these components and signal or data transfer to and from each of these components.

The controller 31 serves as a processor that executes various types of processing necessary for image formation by the image forming apparatus 10. The controller 31 also has the function of controlling the display operation of the display device 21.

The controller 31 accepts, based on a detection signal output from the touch panel 23 or an operation made on a physical key of the operation device 22, an operating instruction input by the user. For example, the controller 31 accepts, through the touch panel 23, a touch gesture on a GUI (graphic user interface) or the like displayed on the screen of the display device 21.

Furthermore, the controller 31 acquires a detection output of the motion sensor (infrared sensor) 25. When the acquired detection output is equal to or larger than a predetermined threshold, the controller 31 determines that a person is present. When the acquired detection output is smaller than the predetermined threshold, the controller 31 determines that no person is present.

On the image forming apparatus 10 having the above structure and configuration, for example, when a user places an original document in the image reading device 11 and operates through the touch panel 23 the GUI or the like displayed on the screen of the display device 21 or operates the operation device 22 to instruct the execution of a copy job, the controller 31 accepts the instruction, allows the image reading device 11 to read an image of the original document, and allows the image forming device 12 to print the image of the original document on a recording paper sheet.

However, if a large number of unspecified people use the image forming apparatus 10, some users may want to avoid inadvertent touch on the touch panel 23 of the image forming apparatus 10. Therefore, it is desirable for the user to know the usage situation and so on of the touch panel 23 to provide for determination of the necessity of cleaning the touch panel 23 and other matters.

As a solution to the above, in the image forming apparatus 10, as shown in FIG. 1, the motion sensor 25 is provided on an apparatus body 7 of the image forming apparatus 10 and disposed in a predetermined location near the display device 21 and the operation device 22. When a user stands in front of the image forming apparatus 10 in order to operate the touch panel 23 provided on the screen of the display device 21 and the operation device 22, the motion sensor 25 senses the user. The controller 31 makes, based on the detection output from the motion sensor 25, a determination of whether or not a person is present around the image forming apparatus 10 and a determination of whether or not a touch gesture has been made on the touch panel 23. The controller 31 counts, based on results of these determinations, the number S of users of the image forming apparatus 10, the number N of touch gestures on the touch panel 23, and the elapsed time T since the latest touch gesture on the touch panel 23. Furthermore, the controller 31 allows the display device 21 to display the number S of users, the number N of touch gestures, and the elapsed time T since the latest touch gesture. The user looks at the number S of users, the number N of touch gestures, and the elapsed time T since the latest touch gesture, which are being displayed on the display device 21, to know the frequency of use of the touch panel 23 and other information and determine the necessity of cleaning the touch panel 23 and other matters.

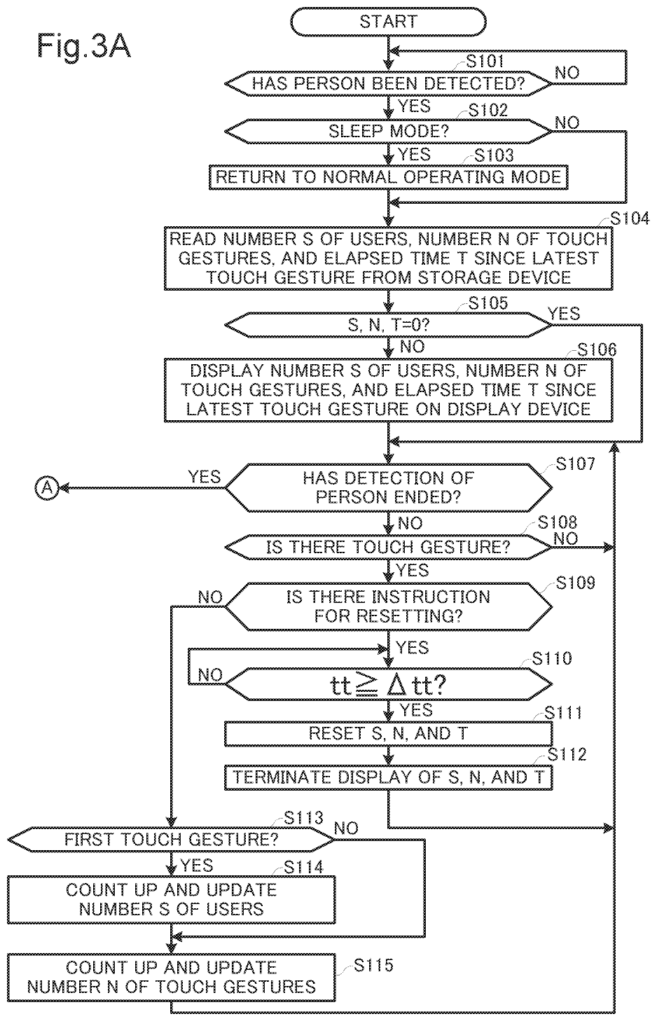

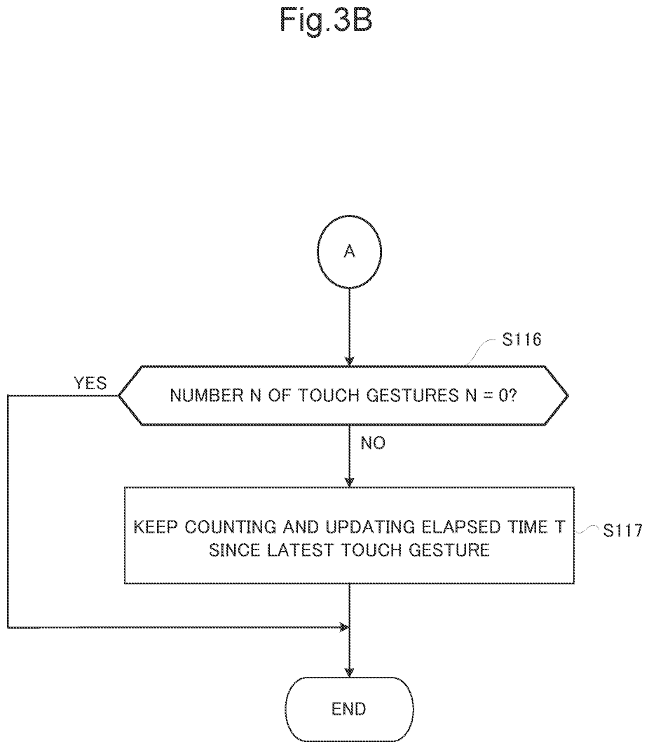

Next, a description will be given of a control procedure for allowing the display device 21 to display the number S of users of the image forming apparatus 10, the number N of touch gestures on the touch panel 23, and the elapsed time T since the latest touch gesture on the touch panel 23, with reference to the flowchart shown in FIGS. 3A and 3B and so on.

The controller 31 acquires a detection output of the motion sensor 25 and waits for the time when the acquired detection output reaches or exceeds a predetermined threshold, i.e., when a user is sensed by the motion sensor 25 (“No” in S101). When a user comes around the image forming apparatus 10, the detection output of the motion sensor 25 reaches or exceeds the threshold. When the detection output of the motion sensor 25 reaches or exceeds the threshold and, thus, the controller 31 determines that a user is present around the image forming apparatus 10 (“Yes” in S101), the controller 31 subsequently determines whether or not the image forming apparatus 10 is put into a sleep mode (S102). The sleep mode is a mode in which the power consumption of the image forming apparatus 10 is saved. It takes a certain amount of time for the image forming apparatus 10 to return from the sleep mode to a normal operating mode.

When determining that the image forming apparatus 10 is put into the sleep mode (“Yes” in S102), the controller 31 allows the image forming apparatus 10 to start a return from the sleep mode to the normal operating mode (S103) and goes to the processing in S104 and subsequent steps.

On the other hand, when determining that the image forming apparatus 10 is not put into the sleep mode (“No” in S102), the controller 31 does not proceed to S103, but goes to the processing in S104 and subsequent steps because the image forming apparatus 10 is in the normal operating mode.

The controller 31 reads from the storage device 28 the number S of users of the image forming apparatus 10, the number N of touch gestures on the touch panel 23, and the elapsed time T since the latest touch gesture on the touch panel 23 (S104). Furthermore, the controller 31 determines whether or not the read number S of users, number N of touch gestures, and elapsed time T since the latest touch gesture are zero (S105). The number S of users, the number N of touch gestures, and the elapsed time T since the latest touch gesture are those counted and stored in the storage device 28 with regard to use of the image forming apparatus 10 before this time by users different from the user determined to be present in S101.

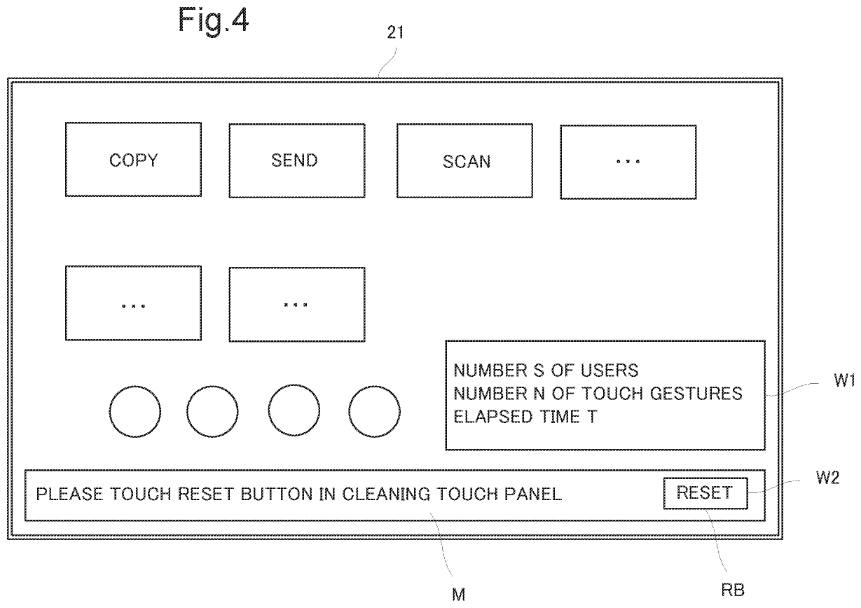

When determining that the number S of users, the number N of touch gestures, and the elapsed time T since the latest touch gesture are not zero (“No” in S105), the controller 31 allows the display device 21 to display, as shown as an example in FIG. 4, the number S of users (S≥1), the number N of touch gestures (N≥1), and the elapsed time T since the latest touch gesture (T≥1) in a window W1 on the screen (S106). Thereafter, the processing goes to S107 and subsequent steps.

In S106, under the display control of the controller 31, the display device 21 displays on the screen, not only the window W1, but also a message M prompting to operate a reset button in cleaning the touch panel 23, and a window W2 representing a RESET button RB.

When, as will be described later, the number S of users, the number N of touch gestures, and the elapsed time T since the latest touch gesture are reset to zero, the window W1 is eliminated from the screen of the display device 21 under the display control of the controller 31. Alternatively, the controller 31 may allow the window W1 to be continuously or intermittently displayed or may limit the display time of the window W1.

Under the display control of the controller 31, the window W2 is not eliminated from the screen of the display device 21, but always displayed on the screen.

On the other hand, when the controller 31 determines that all the number S of users, the number N of touch gestures, and the elapsed time T since the latest touch gesture are zero (“Yes” in S105), the controller 31 does not proceed to S106 and the processing goes to S107. In other words, the window W1 (the number S of users, the number N of touch gestures, and the elapsed time T since the latest touch gesture) is not displayed on the screen of the display device 21 and the processing goes to S107 and subsequent steps.

Then, the controller 31 determines whether the detection output of the motion sensor 25 indicates no detection of the user, i.e., whether the motion sensor 25 is in a state where the detection of a person has ended (S107), and determines whether or not a touch gesture on the touch panel 23 has been made by the user (S108).

When, based on the detection output from the motion sensor 25, the controller 31 does not determine that no user is present, but determines that the motion sensor 25 still continues to detect a person (“No” in S107), and a touch gesture on the touch panel 23 has been detected (“Yes” in S108), i.e., the user makes a touch gesture on the touch panel 23 in front of the image forming apparatus 10, the controller 31 determines whether or not the detected touch gesture is an input of an instruction for resetting; in this case, whether or not the detected touch gesture is one made on the RESET button RB in the window W2 shown in FIG. 4 (S109).

Now, assume that the window W1 is displayed on the screen of the display device 21 and the user looks at the number S of users, the number N of touch gestures, and the elapsed time T since the latest touch gesture in the window W1 to know the frequency of use of the touch panel 23, and looks at the message M in the window W2 to make a touch gesture on the RESET button RB and clean the touch panel 23.

In this case, the controller 31 detects through the touch panel 23 a touch gesture on the RESET button RB and determines that an instruction for resetting based on the touch gesture has been accepted (“Yes” in S109). Then, the controller 31 starts counting the elapsed time tt since the time of acceptance of the instruction for resetting and waits until the elapsed time tt reaches a predetermined cleaning time Δtt (for example, 10 seconds) (“No” in S110). When determining that the elapsed time tt has reached the cleaning time Δtt (“Yes” in S110), the controller 31 resets the number S of users, the number N of touch gestures, and the elapsed time T since the latest touch gesture, which are stored in the storage device 28, to zero (S111) and eliminates the window W1 (the number S of users, the number N of touch gestures, and the elapsed time T since the latest touch gesture) from the screen of the display device 21 (S112). The reason for this is that the cleaning of the touch panel 23 can be considered to be completed. Thereafter, the processing goes back to S107.

A description will be given below of processing in the case where, regardless of whether or not the window W1 is displayed on the screen of the display device 21, a user does not make a touch gesture on the RESET button RB, but makes a touch gesture on the GUI or the like displayed on the screen of the display device 21 in order to execute a copy job or so on.

In this case, based on a detection output from the motion sensor 25, the controller 31 does not determine that no user is present, but determines that the motion sensor 25 still continues to detect a person (“No” in S107), and detects a touch gesture on the touch panel 23 (“Yes” in S108). The controller 31 detects the touch gesture through the touch panel 23, but does not detect a touch gesture on the RESET button RB and determines that no instruction for resetting based on the touch gesture has been accepted (“No” in S109). Subsequently, the controller 31 determines whether the detected touch gesture is a first touch gesture since it has determined in S101, based on the detection output from the motion sensor 25, that a user is present (S113).

For example, when determining that the detected touch gesture is the first touch gesture (“Yes” in S113), the controller 31 counts up and updates the number S of users stored in the storage device 28 (S114). Furthermore, the controller 31 counts up and updates the number N of touch gestures stored in the storage device 28 (S115).

On the other hand, when determining that the detected touch gesture is not the first touch gesture (“No” in S113), the controller 31 does not count up the number S of users in S114, but counts up and updates the number N of touch gestures stored in the storage device 28 (S115). Thereafter, the processing goes back to S107.

For example, when the number S of users, the number N of touch gestures, and the elapsed time T since the latest touch gesture, all of which are stored in the storage device 28, are zero, upon detection of a first touch gesture since the determination, based on a detection output from the motion sensor 25, that a user is present, the number S of users stored in the storage device 28 is counted up from 0 to 1 and the number N of touch gestures stored in the storage device 28 is counted up from 0 to 1.

Then, even if a second or later touch gesture on the touch panel 23 is detected, the number S of users is not counted up. Each time a second or later touch gesture on the touch panel 23 is detected, the number N of touch gestures is counted up one by one.

When the number S of users stored in the storage device 28 is (S≥1), the number N of touch gestures stored therein is (N≥1), and the elapsed time T since the latest touch gesture stored therein is (T≥1), upon detection of a first touch gesture since the determination, based on a detection output from the motion sensor 25, that a user is present, the number S of users is counted up to (S+1) and the number N of touch gestures is counted up to (N+1). Then, even if a second or later touch gesture on the touch panel 23 is detected, the number S of users is not counted up. Each time a second or later touch gesture on the touch panel 23 is detected, the number N of touch gestures is counted up one by one.

In other words, upon detection of a first touch gesture since the determination, based on a detection output from the motion sensor 25, that a user is present, the number S of users is counted up by adding this user to the number S of users and the number N of touch gestures is counted up. Then, each time a second or later touch gesture is detected, the number N of touch gestures is further counted up.

Thereafter, when the user completes the use of the image forming apparatus 10 and leaves the image forming apparatus 10, the controller 31 does not detect a touch gesture on the touch panel 23 (“No” is S108), determines, based on a detection output from the motion sensor 25, that the user is no longer present (“Yes” in S107), and, in this case, determines whether or not the number N of touch gestures stored in the storage device 28 is zero (S116).

For example, when determining that the number N of touch gestures is not zero (“No” in S116), i.e., when the number S of users, the number N of touch gestures, and the elapsed time T since the latest touch gesture have not been reset, the controller 31 starts counting the elapsed time T since the latest touch gesture and updates the elapsed time T stored in the storage device 28 (S117), for example, with every one minute of the elapsed time T.

Thereafter, the controller 31 ends the control procedure shown in FIGS. 3A and 3B, but continues to update the elapsed time T stored in the storage device 28 until it restarts the control procedure shown in FIGS. 3A and 3B.

On the other hand, when determining that the number N of touch gestures is zero (“Yes” in S116), i.e., when the number S of users, the number N of touch gestures, and the elapsed time T since the latest touch gesture have been reset, the controller 31 does not update the number S, the number N, and the elapsed time T. In this case, the control procedure shown in FIGS. 3A and 3B ends.

Before completing the use of the image forming apparatus 10 and leaving the image forming apparatus 10, the user may make a touch gesture on the RESET button RB to input an instruction for resetting and clean the touch panel 23. In this case, the controller 31 determines that the instruction for resetting has been accepted (“Yes” in S109) and determines that the elapsed time tt has reached the cleaning time Δtt (for example, 10 seconds) (“Yes” in S110). Thus, the cleaning of the touch panel 23 can be considered to be completed. Therefore, the controller 31 resets the number S of users, the number N of touch gestures, and the elapsed time T since the latest touch gesture, which are stored in the storage device 28, to zero (S111) and eliminates the window W1 from the screen of the display device 21 (S112). Thereafter, the processing goes back to S107.

Then, the controller 31 determines, based on a detection output from the motion sensor 25, that the user is no longer present (“Yes” in S107). When determining that the number N of touch gestures stored in the storage device 28 is zero (“Yes” in S116), the controller 31 does not update the number S of users, the number N of touch gestures, and the elapsed time T since the latest touch gesture. In this case, the controller 31 ends the control procedure shown in FIGS. 3A and 3B.

As thus far described, in this embodiment, the controller 31 makes a determination of whether or not a person in front of the image forming apparatus 10 has been detected by the motion sensor 25, makes a determination of whether or not a touch gesture has been made on the touch panel 23, and counts, based on results of these determinations, the number S of users, the number N of touch gestures, and the elapsed time T since the latest touch gesture, and allows the display device 21 to display the number S of users, the number N of touch gestures, and the elapsed time T since the latest touch gesture. Therefore, the user can know how the touch panel 23 is used and determine the necessity of cleaning the touch panel 23 and other matters.

For example, since the apparatus disclosed in BACKGROUND reads the surface of the touch panel or takes an image of the surface thereof with a scanner, a camera or the like to detect a dirt on the surface of the touch panel, it cannot detect a dirt which can neither be read nor imaged. For example, viruses, bacteria, and the like cannot be detected. Therefore, even if the surface of the touch panel is contaminated with viruses or bacteria, the apparatus cannot deal with this problem.

Unlike the above, in this embodiment, the cleaning of the touch panel can be properly supported by determining how the touch panel is used and displaying the determination result on the display device.

In the above embodiment, the controller 31 determines the presence or absence of a user based on whether or not the detection output of the motion sensor 25 is equal to or larger than the predetermined threshold. The threshold may be changed to appropriately adjust the sensitivity for detection of a user by the motion sensor 25. For example, the controller 31 performs at least one of the following controls: (i) the sensitivity for detection of a person by the motion sensor 25 is set to be higher with increasing number S of users; (ii) the sensitivity for detection of a person by the motion sensor 25 is set to be higher with increasing number N of touch gesture; and (iii) the sensitivity for detection of a person by the motion sensor 25 is set to be higher with decreasing elapsed time T.

Thus, when a user is coming close to the image forming apparatus 10, the timing with which the detection output of the motion sensor 25 reaches or exceeds the threshold can be advanced. The controller 31 detects, based on the detection output of the motion sensor 25, a user coming close to the image forming apparatus 10 with an earlier timing to accelerate the return of the image forming apparatus 10 from the sleep mode to the normal operating mode and allows the display device 21 to more promptly display the number S of users, the number N of touch gestures, and the elapsed time T since the latest touch gesture to advance the timing with which these pieces of information are notified to the user. Thus, when coming in front of the image forming apparatus 10, the user can certainly view these pieces of information S, N, and T on the screen of the display device 21 and avoid inadvertent touch on the touch panel 23.

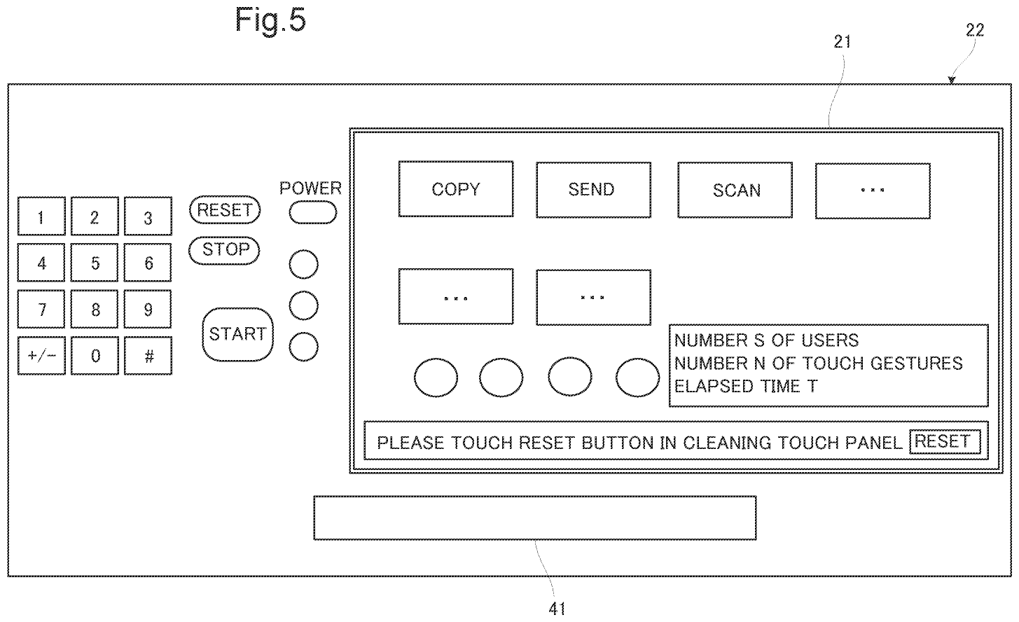

Furthermore, it is possible that an LED 41 is provided on the operation device 22 of the image forming apparatus 10 as shown in FIG. 5 and the controller 31 turns on the LED 41 or changes the interval of blinking of the LED 41 depending on the number S of users, the number N of touch gestures or the elapsed time T since the latest touch gesture. For example, the controller 31 performs at least one of the following controls: (i) the interval of blinking of the LED 41 is set to be shorter with increasing number S of users; (ii) the interval of blinking of the LED 41 is set to be shorter with increasing number N of touch gesture; and (iii) the interval of blinking of the LED 41 is set to be shorter with decreasing elapsed time T.

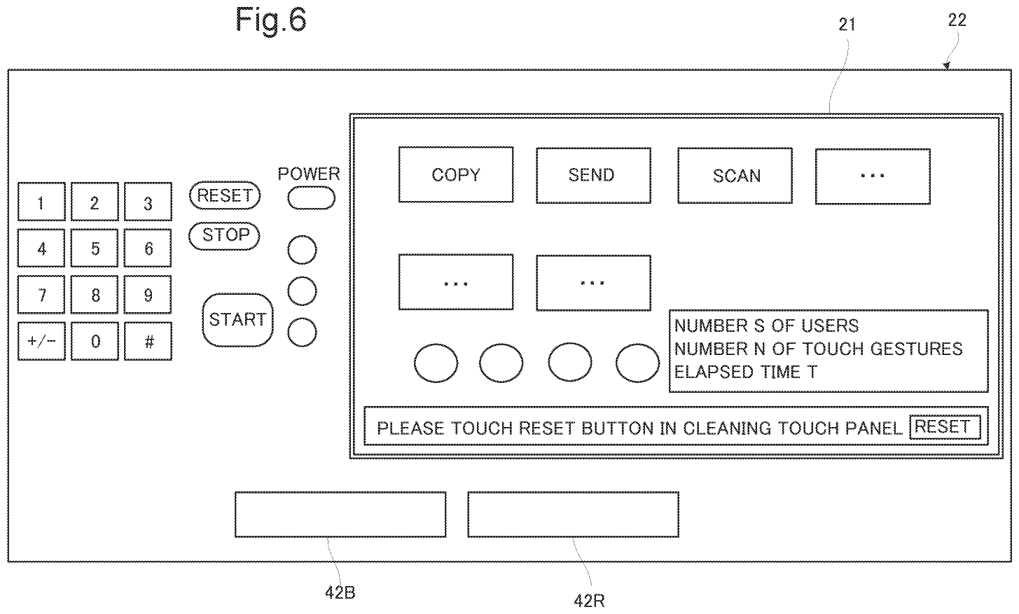

Alternatively, it is possible that a blue LED 42B and a red LED 42R are provided on the operation device 22 of the image forming apparatus 10 as shown in FIG. 6 and the controller 31 selectively turns on or blinks one of the LEDs 42B and 42R depending on the number S of users, the number N of touch gestures or the elapsed time T since the latest touch gesture. Still alternatively, it is possible that a larger number of LEDs of different colors are provided and the controller 31 selectively turns on or blinks the LEDs of different colors depending on the number S, the number N or the elapsed time T. Thus, the frequency of use of the touch panel 23 and other information can be notified, with a further earlier timing, to the user coming close to the image forming apparatus 10.

Although in the above embodiment the controller 31 allows the display device 21 to display the number S of users, the number N of touch gestures, and the elapsed time T since the latest touch gesture, the controller 31 may allow the display device 21 to display one of the number S of users, the number N of touch gestures, and the elapsed time T since the latest touch gesture or selectively display two of them. Also in this case, the user can know the frequency of use of the image forming apparatus 10 and other information to provide for determination of the necessity of cleaning the touch panel 23 and other matters.

For example, the controller 31 counts the number N of touch gestures based on a result of determination of whether or not a touch gesture has been made on the touch panel 23, and allows the display device 21 to display only the number N of touch gestures. In this case, the motion sensor 25 may be eliminated.

Alternatively, the controller 31 may allow the display device 21 to always display or intermittently display the number S of users, the number N of touch gestures or the elapsed time T since the latest touch gesture, regardless of whether a person is detected by the motion sensor 25.

Although the description in the above embodiment has been given using a multifunction peripheral, the multifunction peripheral is merely illustrative and the image forming apparatus may be a copier, a printer, a facsimile device or other types of image forming apparatuses.

The structure, configuration, and processing of the above embodiment described with reference to FIGS. 1 to 6 are merely illustrative and are not intended to limit the present disclosure to them.

While the present disclosure has been described in detail with reference to the embodiments thereof, it would be apparent to those skilled in the art the various changes and modifications may be made therein within the scope defined by the appended claims.

What is claimed is:

1. An image forming apparatus comprising:
a display device;
a touch panel provided on a screen of the display device;
a motion sensor that detects a person present around the image forming apparatus; and
a control device including a processor and functioning, through the processor executing a control program, as a controller that makes a determination of whether or not a person present around the image forming apparatus has been detected by the motion sensor, makes a determination of whether or not a touch gesture has been made on the touch panel, counts, based on results of the determinations, a number of users of the image forming apparatus, a number of touch gestures on the touch panel or an elapsed time since a latest touch gesture on the touch panel, and allows the display device to display the number of users, the number of touch gestures or the elapsed time.

2. The image forming apparatus according to claim 1, wherein
the controller determines whether a touch gesture detected by the touch panel is a first touch gesture since the controller has determined, based on a detection output from the motion sensor, that a user is present,
when determining that the detected touch gesture is the first touch gesture, the controller counts up the number of users and counts up the number of touch gestures, and
when determining that the detected touch gesture is not the first touch gesture, the controller keeps from counting up the number of users, but counts up the number of touch gestures.

3. The image forming apparatus according to claim 1,
further comprising a reset button that accepts an instruction for resetting from a user,
wherein when the controller determines that the instruction for resetting has been accepted by the reset button and an elapsed time tt since a time of acceptance of the instruction for resetting has reached a predetermined cleaning time Δtt, the controller resets the number of users, the number of touch gestures or the elapsed time.

4. The image forming apparatus according to claim 3,
further comprising a storage device that stores the number of users, the number of touch gestures or the elapsed time since the latest touch gesture,
wherein when the image forming apparatus returns from a sleep mode to a normal operating mode, the controller determines whether or not the number of users, the number of touch gestures or the elapsed time is stored in the storage device, and
when determining that the number of users, the number of touch gestures or the elapsed time is stored in the storage device, the controller reads the number of users, the number of touch gestures or the elapsed time from the storage device and allows the display device to display the number of users, the number of touch gestures or the elapsed time.

5. The image forming apparatus according to claim 1, wherein the controller performs one of the following controls:
a sensitivity for detection of a person by the motion sensor is set to be higher with increasing number of users;
the sensitivity for detection of a person by the motion sensor is set to be higher with increasing number of touch gesture; and
the sensitivity for detection of a person by the motion sensor is set to be higher with decreasing elapsed time.

6. The image forming apparatus according to claim 1,
further comprising a light-emitting device,
wherein the controller performs one of the following controls:
an interval of blinking of the light-emitting device is set to be shorter with increasing number of users;
the interval of blinking of the light-emitting device is set to be shorter with increasing number of touch gestures; and
the interval of blinking of the light-emitting device is set to be shorter with decreasing elapsed time.

7. The image forming apparatus according to claim 1,
further comprising a plurality of different light-emitting devices that emit light of different colors,
wherein the controller selects one of the light-emitting devices depending on the number of users, the number of touch gestures or the elapsed time and turns on or blinks the selected light-emitting device.

8. The image forming apparatus according to claim 1, wherein the controller allows the display device to display the number of users, the number of touch gestures or the elapsed time and concurrently display a message prompting to clean the touch panel.
